(19) United States
(12) Patent Application Publication
(10) Pub. No.: US 2011/0295798 A1
(43) Pub. Date: Dec. 1, 2011

(54) MOBILE MIRROR DRIVE AND REMOTE ACCESS SYSTEM

(76) Inventor: Joseph Shain, Rehovot (IL)

(21) Appl. No.: 12/788,342

(22) Filed: May 27, 2010

(51) Int. Cl. G06F 17/30; G06F 13/12; G06F 12/00

(52) U.S. Cl. 707/617; 711/104; 710/63; 709/219; 707/E17.007; 711/E12.001

(57) ABSTRACT

A solid state memory stores a mirror image of a computer hard drive. The solid state memory is coupled with a wireless communication chip, such as 3G, in order to enable dynamically updating the files on the solid state memory. Any modifications done to the files on the hard drive are synced with the files on the solid state memory. Similarly, any modifications done to the files on the solid state memory are synced with the files on the hard drive.

### FIELD OF THE INVENTION

The field of the present invention is the Internet and data networks and their use in copying and storing computer files. The present invention teaches using a small phone to store a synced copy of all files on a remote computer hard drive. The synchronization of files is done over the Internet or advanced telephony (inter alia, 3G) network.

### BACKGROUND OF THE INVENTION

Flash memory drives that connect to a computer via USB are well known and very popular. Several large manufacturers of the products include SanDisk, Kingston and others. These flash drives are commonly known as “disk on key.”

A USB flash drive consists of a flash memory data storage device integrated with a USB (Universal Serial Bus) 1.1 or 2.0 interface. USB flash drives are typically removable and rewritable, and much smaller than a floppy disk. Most weigh less than 30 g (1 oz). Storage capacities in 2010 can be as large as 256 GB with steady improvements in size and price per capacity expected. Some allow 1 million write or erase cycles and have a 10-year data retention cycle.

USB flash drives are often used for the same purposes as floppy disks were. They are smaller, faster, have thousands of times more capacity, and are more durable and reliable because of their lack of moving parts. Until approximately 2005, most desktop and laptop computers were supplied with floppy disk drives, but most recent equipment has abandoned floppy disk drives in favor of USB ports.

Flash drives use the USB mass storage standard, supported natively by modern operating systems such as Windows, Mac OS X, Linux, and other Unix-like systems. USB drives with USB 2.0 support can store more data and transfer faster than a much larger optical disc drive and can be read by most other systems such as the PlayStation 3.

Nothing moves mechanically in a flash drive; the term drive persists because computers read and write flash-drive data using the same system commands as for a mechanical disk drive, with the storage appearing to the computer operating system and user interface as just another drive. Flash drives are very robust mechanically.

A flash drive consists of a small printed circuit board carrying the circuit elements and a USB connector, insulated electrically and protected inside a plastic, metal, or rubberized case which can be carried in a pocket or on a key chain, for example. The USB connector may be protected by a removable cap or by retracting into the body of the drive, although it is not likely to be damaged if unprotected. Most flash drives use a standard type-A USB connection allowing plugging into a port on a personal computer, but drives for other interfaces also exist.

Most USB flash drives draw their power from the USB connection, and do not require a battery. Some devices that combine the functionality of a digital audio player with flash-drive-type storage require a battery for the player function.

Flash drives are commonly used to copy files from a first computer to a second computer. Another use is for saving copies of files from a computer to avoid loss of files in case of future loss or damage to that computer.

The method of use is to: (i) insert the flash drive into the first computer; (ii) find and select the desired files on the first computer; (iii) copy the desired files from the first computer to the flash drive; (iv) remove the flash drive from the first computer and insert the flash drive into the second computer; and, (v) copy the files from the flash drive to the second computer or execute a program on the second computer that displays the selected files directly off the flash drive.

While this method of work is extremely popular, it would be advantageous to have a flash drive that is always kept in sync with the first computer hard drive. In this case, copies all of the data files on the first computer are automatically stored to the flash drive. When a user wishes to copy a particular file to a second computer the user does not need to copy the files off of the first computer. Rather, he only needs to insert the flash drive into the second computer and move the desired files to the second computer's hard drive, or execute a program on the second computer that displays the desired files directly off the flash drive. This makes copying files much more convenient.

Furthermore, many users take their laptop computers with them to business meetings because they want to have access to all of their files at the meeting. It would be desirable to enable the user to take only his usb flash drive without any preparation and use a computer at the customer site to display and update any of the user's files.

During a visit to a customer location, if a user copies one or more files provided by the customer onto the user's flash drive, it would also be advantageous to have this same flash drive sync the new files with the files on the user's personal computer (e.g., laptop), automatically, without requiring any specific action by the user. Thus, the user would not need to insert the flash drive containing the customer files into the user's personal computer. Also, the user would not need to select the customer files and drag them, or otherwise copy them, to the user's personal computer in order to copy the new files from the flash drive. This applies to new files copied to the flash drive from a second personal computer into which the flash drive is connected via USB. This also applies to updates (changes, modifications, edits) made to existing files on the flash drive. This also applies to new files created on the flash drive.

It would be beneficial to provide a flash drive that is kept in sync with a user's computer, thereby overcoming the drawbacks of conventional flash drives described above. Many move advantages will become apparent in the course of the detailed description.

### SUMMARY OF THE DESCRIPTION

The present invention provides convenient, small flash memory devices that provide constantly up-to-date mirror images of a user's computer hard drive.

Aspects of the present invention relate to devices and methods, including inter alia (i) small telephony devices coupled to flash memory, (ii) methods for providing access to all files on a user's computer hard drive, through a small telephony device, (iv) methods for providing access to all files on a user's computer hard drive, through a small telephony device, when the capacity of the device is not large enough to store all of the user's files.

The invention teaches a handheld, dynamically updated mirror disk, comprising: a solid state memory; components operative to perform read and write operations on said memory; communication means operative to transfer data between the memory and a remote server; and connection means operative to (i) connect the mirror disk to a first computer, and (ii) transfer data between the first computer and the mirror disk.

One objective of the present invention is to enable a user to access any and all files contained on a second computer by simply inserting the mirror disk into the first computer and viewing the second imputer's entire file system. In the context of the present invention, the term “file system” means all directories and files accessible through a file browser program, such as Microsoft Explorer and Macintosh Finder, beginning at a designated hard drive (e.g., disk c: on typical personal computers (PCs) running the Microsoft Windows operating system, and MacHD on a computer running the Apple OSX operating system) and including the contents of all subdirectories contained therein. According to one embodiment, three versions of the file system are stored: (i) on the second computer; (ii) on a remote server in the Internet cloud; and (iii) on the mirror disk. The remote server is in communication with both the second computer (over an Internet connection, inter alia ADSL or wifi), and the mirror disk (over 3G telephony or wifi connection).

A program running on the remote server synchronizes all three file systems. Any update or modification to a file or to the file system on either the second computer, or on the mirror disk, is detected by the remote server. In this event, the remote server copies the updated or modified information to itself and to file system that was not modified or updated. In this way, all three sets of files are kept in sync and a user can use any version knowing it is the latest version of the file and also that any updates he makes locally will be automatically stored to the remaining locations. For example, if the user makes an update to a file stored on the mirror drive, that update is stored to the remote server and to the second computer. When the user subsequently opens the local copy of the file on the second computer, that local copy contains the update.

According to an embodiment of the invention, the entire structure of directories and file names are stored on the mirror disk by the remote server, but not all of the actual files are stored on the mirror drive. When a user performs an action on a selected file on the mirror drive, that file is copied to the mirror drive from the remote serve over the communication means.

According to an embodiment of the invention, all metadata of the file system are maintained separately from the actual files. All metadata are stored on the mirror disk by the remote server, but not all of the actual files are stored on the mirror drive. Metadata is information about the files. When a user performs an action on a selected file on the mirror drive, that file is copied to the mirror drive from the remote serve over the communication means.

The present invention teaches methods of providing copies of files in multiple locations. The method includes the following steps:

providing a file system on a primary computer;

synchronizing the primary computer file system with a mirror disk by means of a remote server;

enabling file system operations on the synchronized mirror disk file system using a secondary computer connected to the mirror disk.

File system operations include, inter alia, copying or moving a file from the secondary computer to the mirror disk, copying or moving a file from the mirror disk to the secondary computer, creating a new directory on the mirror disk, deleting a directory on the mirror disk, opening a file stored on the mirror disk using a program running on the secondary computer, deleting a file from the mirror disk, replacing a file on the mirror disk with an edited or modified version of the file. The invention enables performing at least one of these file system operations on the synchronized mirror disk file system.

When copying a file from the secondary computer to the mirror disk synchronized file system, the method further includes copying the copied file to the primary computer file system by means of the remote server. The location within the directory structure at which the file is stored on the primary disk is the same location at which the file is stored on the mirror disk. For example, if the user copied the file to the following location on the mirror disk file system:

c:\my documents\work\customers\Tyro\presentations\

the file is also copied to that same location on the primary computer. According to the prior art, a user would save a file from the secondary computer to a disk-or-key. Later, the user inserts the disk-on-key into his primary computer and needs to manually browse the primary computer file system and copy the file from the disk-on-key to a location on his primary computer. The present invention obviates the need for the user to insert his disk-on-key into his primary computer in order to save the file to a desired location.

When a user modifies a file on the mirror disk synchronized file system, the method further includes synchronizing the modified file with the primary computer file system by means of said remote server. In this way, the users edits are automatically placed on the primary computer into the original file at its original location.

Occasionally, a primary computer file is not stored on the mirror disk. For example, this occurs when the amount of memory occupied by all primary computer files is larger than the mirror disk storage capacity. In such cases, when a user calls a function on a mirror disk file, the mirror disk software determines whether the selected file is stored on the mirror disk. If it is not stored on the mirror disk, the selected file is copied to the mirror disk by means of the remote server and then the function is executed on the copied file.

Ideally in the situation just described, the mirror disk is configured to maintain some free memory in order to accommodate a file that needs to be copied to the mirror disk without having to first delete a file from the mirror disk. This is especially true when the time required for deleting a file from the mirror disk is significant. This is the case with many types of flash memory. However, after the file has been copied and used, it is advantageous to free up sufficient memory to enable a subsequent file copy. Therefore, the method of the present invention includes generating priority rankings for the files stored on the mirror disk; and, once the mirror disk is idle, deleting at least one file from the mirror disk in order to restore a sufficient amount of free memory. The decision which file or files to delete is executed by software running on the mirror disk and is based the priority rankings. Alternatively, the ranking process is performed by the remote server and the remote server sends an instruction to the mirror disk regarding which files to delete.

The ranking process is very similar to schemes employed with cache memory to avoid cache misses and to facilitate fast copy of data to the cache from main memory. Whereas cache schemes generally deal with fine resolution, such as double-word (32-bit or 64-bit) units of data, the scheme in the present invention deals with entire files: the entire file is assigned a rank and it is either retained in its entirety or entirely deleted based on its ranking and the free space requirements. Alternative schemes divide files into sections to enable retaining a portion of a file on the memory disk and retrieving the remainder if the file is operated upon. This allows the secondary computer to open the beginning pages of a document, for example, and allows the user to view those pages while the remainder of the document is retrieved by the remote server.

### BRIEF DESCRIPTION OF THE DRAWINGS

The present invention will be more fully understood and appreciated from the following detailed description, taken in conjunction with the drawings in which:

FIGS. 1-4 are diagrams illustrating data flow between a primary computer, a remote server, a mirror disk and a secondary computer, in accordance with embodiments of the present invention;

FIG. 5 is a simplified diagram of the main elements in a mirror disk, in accordance with an embodiment of the present invention;

FIGS. 6-9 are diagrams illustrating data flow between a primary computer, a remote server, a mirror disk and a secondary computer, in accordance with embodiments of the present invention;

FIG. 10 is a flow diagram for a method of opening a file using a mirror disk, in accordance with an embodiment of the present invention;

FIG. 11 is a flow diagram for a method of opening a file using a mirror disk, and restoring sufficient free memory for a subsequent file copy, in accordance with an embodiment of the present invention.

### DETAILED DESCRIPTION

Aspects of the present invention relate to small usb flash drives that include a communication device for receiving data from the Internet. Aspects of the present invention also relate to methods for storing copies of files from a first computer to a remote site over an Internet connection, and further, to methods for updating multiple computers with a latest version of files from the remote site.

According to embodiments of the present invention, a system synchronizes files on a first computer with files stored at a remote location. Communication between the remote location and the first computer occurs over the Internet. Additional computers or handheld devices are synchronized with the file image stored at the remote location. When a file is updated at one location, that update is stored to the remote location and pushed from the remote location to all additional computers configured to be kept in sync.

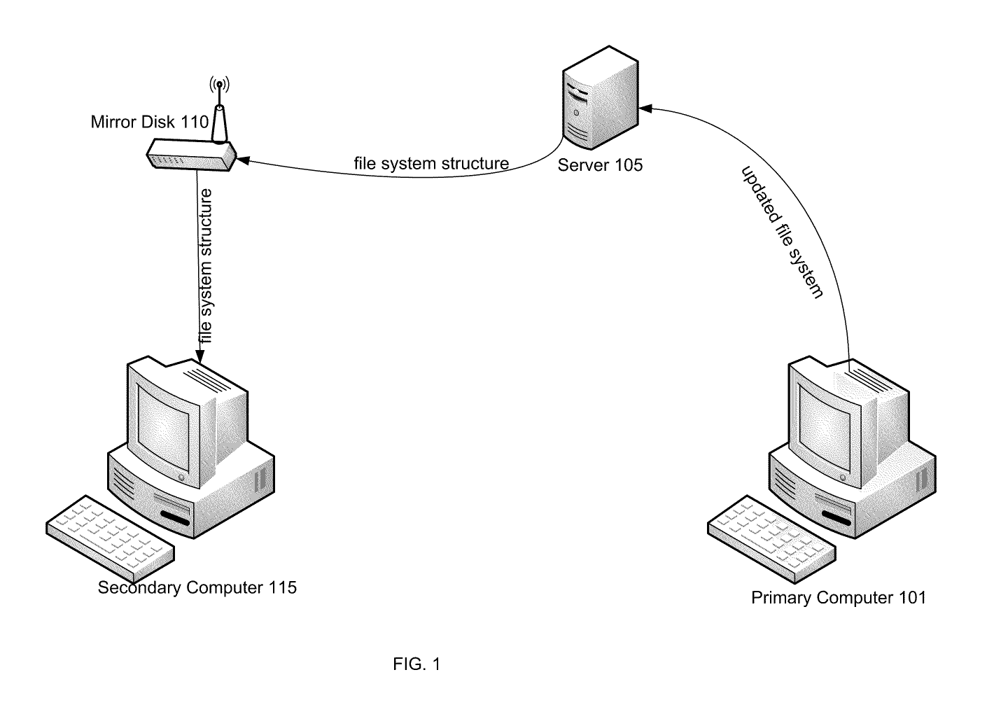

Reference is now made to FIG. 1 which illustrates the flow of data to the mirror disk of the present invention. Primary computer 101 stores files in a local file system. Thus, primary computer 101 stores two sets of data: (i) the directory structure and filenames that enable a user to access a particular file; and, (ii) all of the actual files. Primary computer 101 connects over the Internet to remote server 105. Primary computer 101 stores its entire file system to remote server 105. This includes both, the directory structure and filenames that enable a user to access a particular file; and, all of the actual files. Thus server 105 provides a backup of primary computer 101.

Handheld mirror disk 110 is connected wirelessly to server 105. This wireless connection may be over 3G telephony network, wifi, or other network. Mirror disk 110 has a fixed address on the network in order to identify it to the remote server. This is present in phones connected to a 3G network. Server 105 sends the directory structure and filenames of primary computer 101 to mirror disk 110. This enables a user of mirror disk 110 to browse the file system of primary computer 101 by inserting mirror disk 110 into secondary computer 115 and browsing the directory structure and filenames stored on mirror disk 110 on the monitor of secondary computer 115.

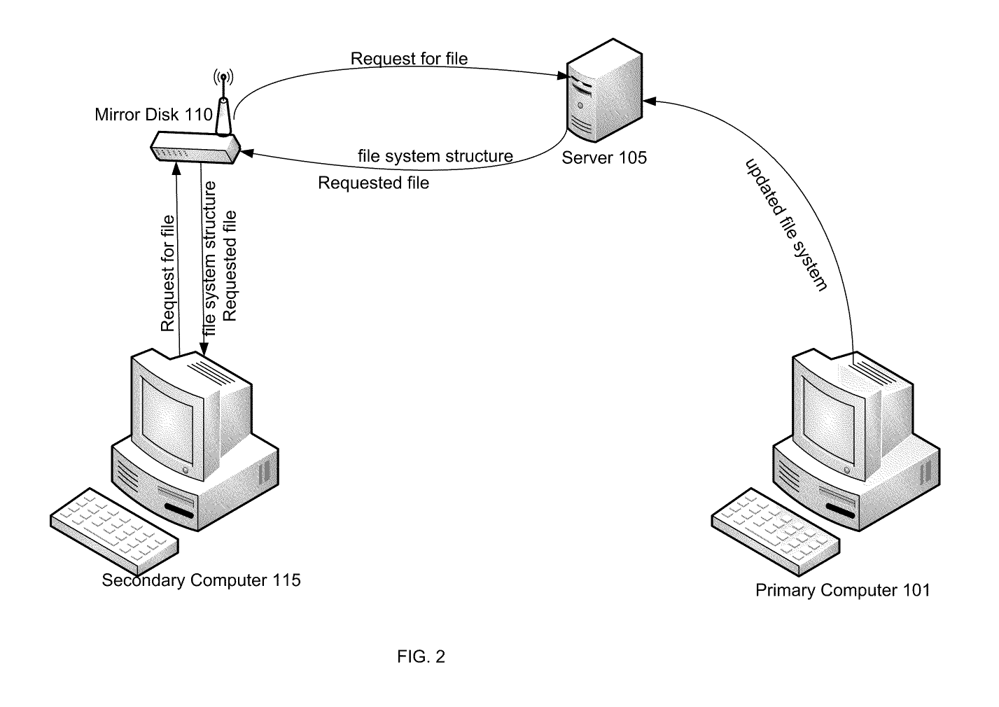

When the user, browsing files in this way, activates a function on a selected file, inter alia, file copy or file open, mirror disk 110 issues a request for the selected file to remote server 105. This is illustrated in FIG. 2. In turn, server 105 sends the requested file to mirror disk 110 for activation. For example, the user copies the selected file to second m computer 115. Alternatively, the user opens the selected file on secondary computer 115 by running an associated program on secondary computer 115. For example, the selected file is a PowerPoint presentation. In this case, the user opens the PowerPoint program on secondary computer 115 and opens the selected file (now copied from remote server 105 to mirror disk 110) on secondary computer 115.

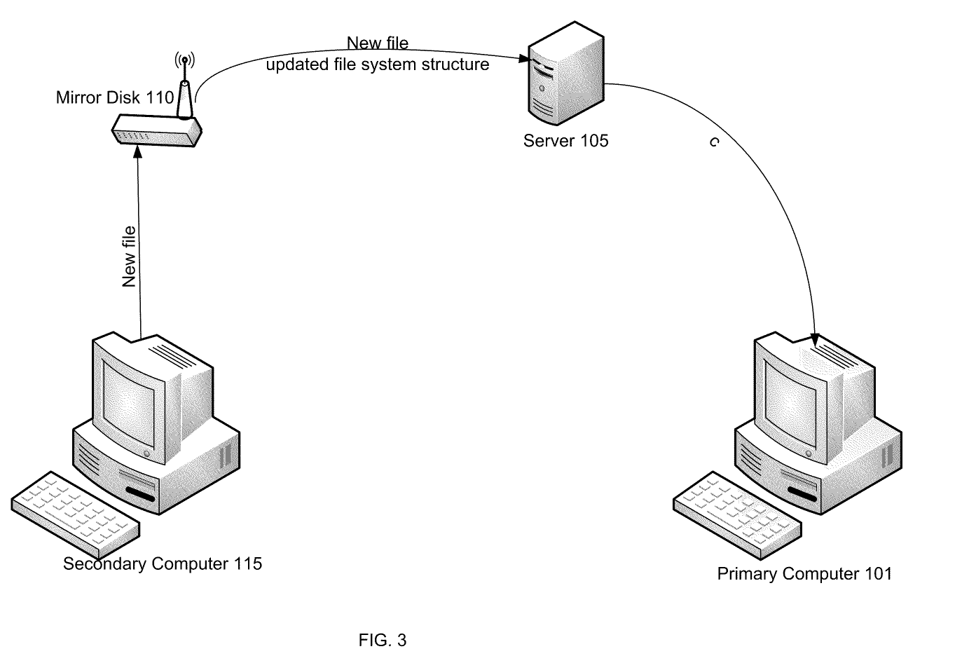

Reference is now made to FIG. 3 which illustrates data flow when a user adds a new file to mirror disk 110 from secondary computer 115. In this case a file from secondary computer 115 is copied to mirror disk 110 and stored within the directory structure on mirror disk 110 at a location selected by the user. The copied file is then copied to remote server 105 and stored within the directory structure on remote server 105 at the location selected by the user, since the directory structure on mirror disk 110, remote server 105 and primary computer 101 are identical. The file is then copied to primary computer 101 and stored within the directory structure on primary computer 101 at the location selected by the user.

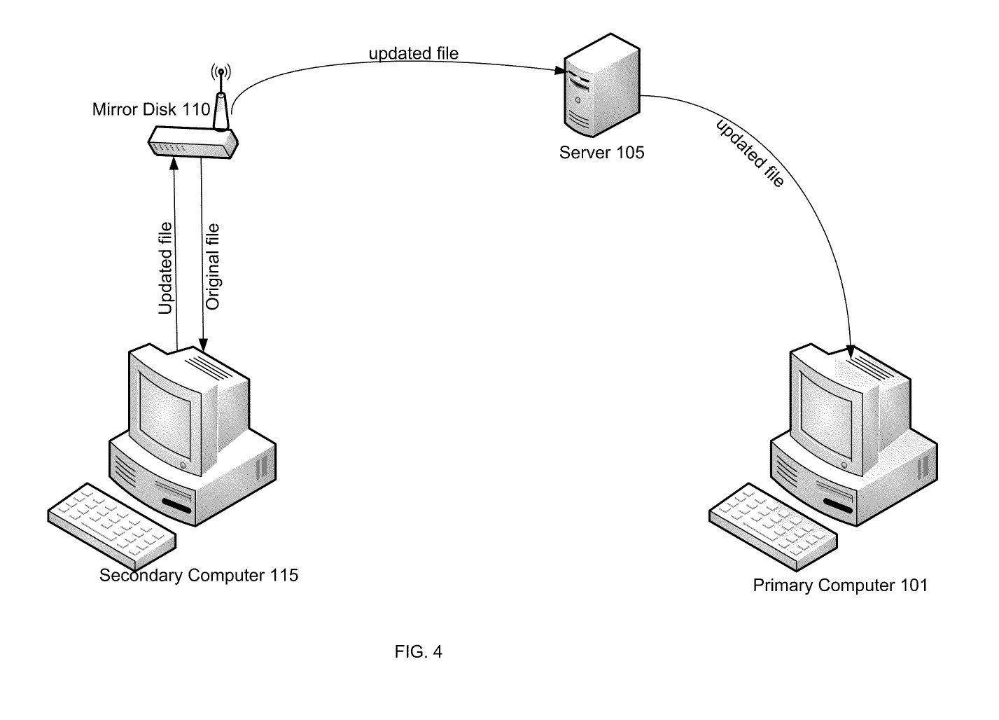

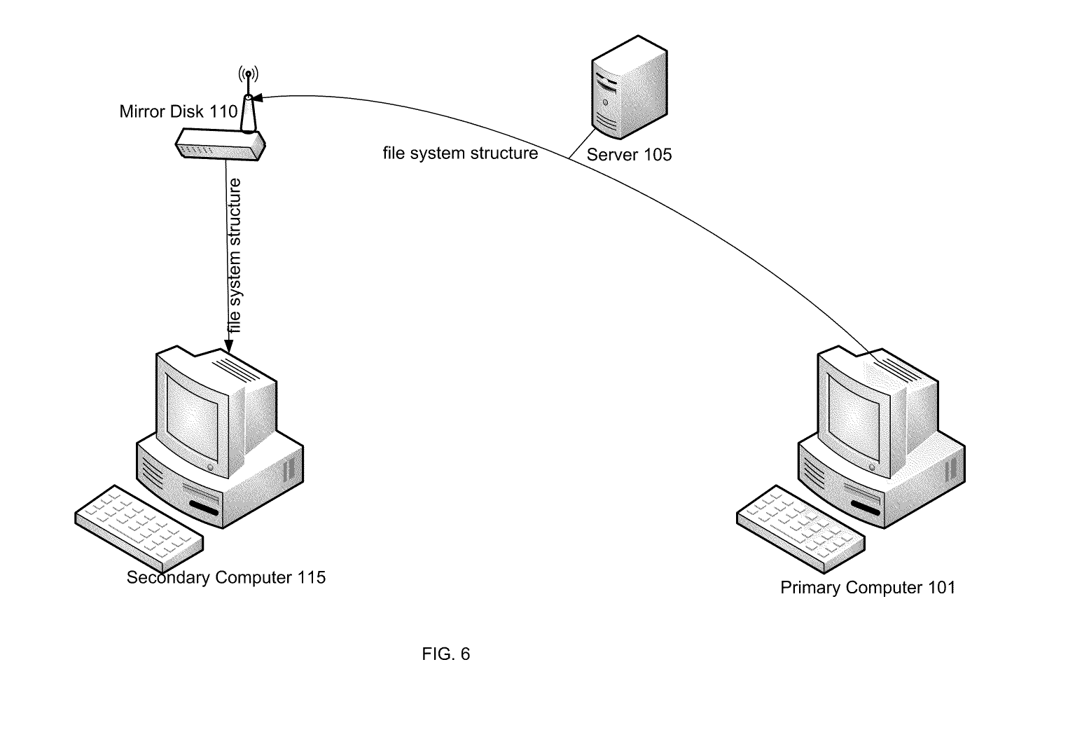

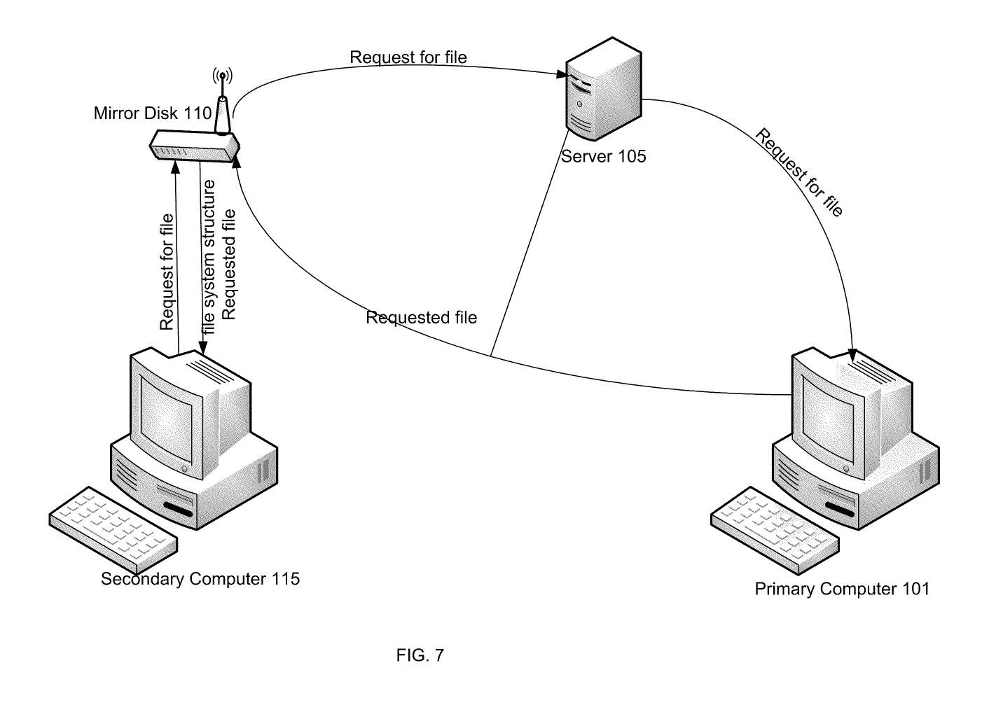

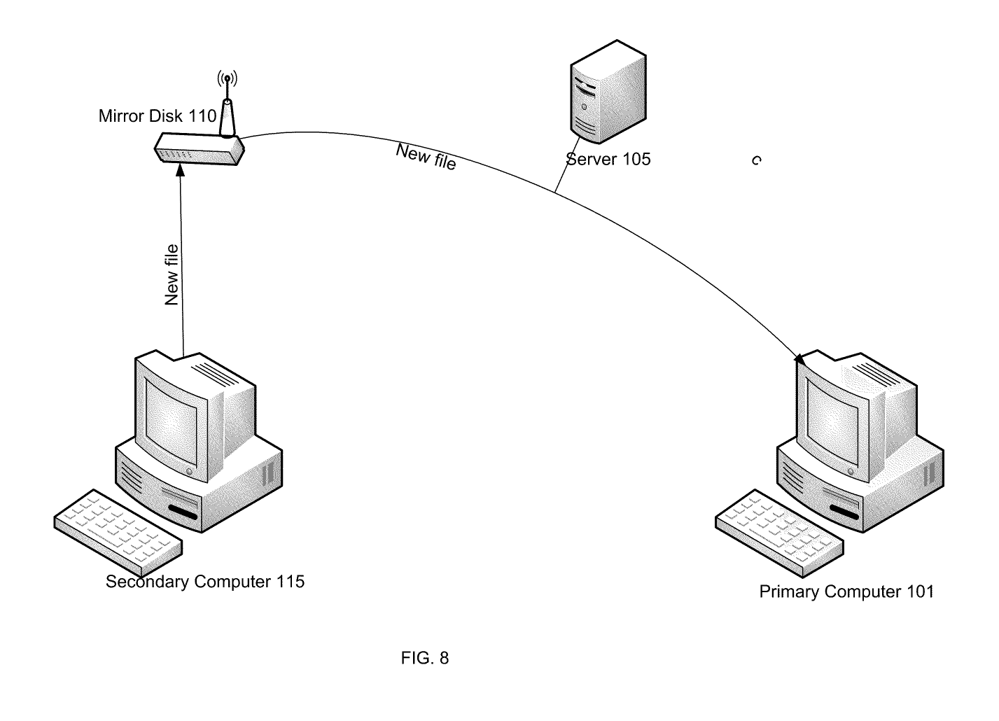

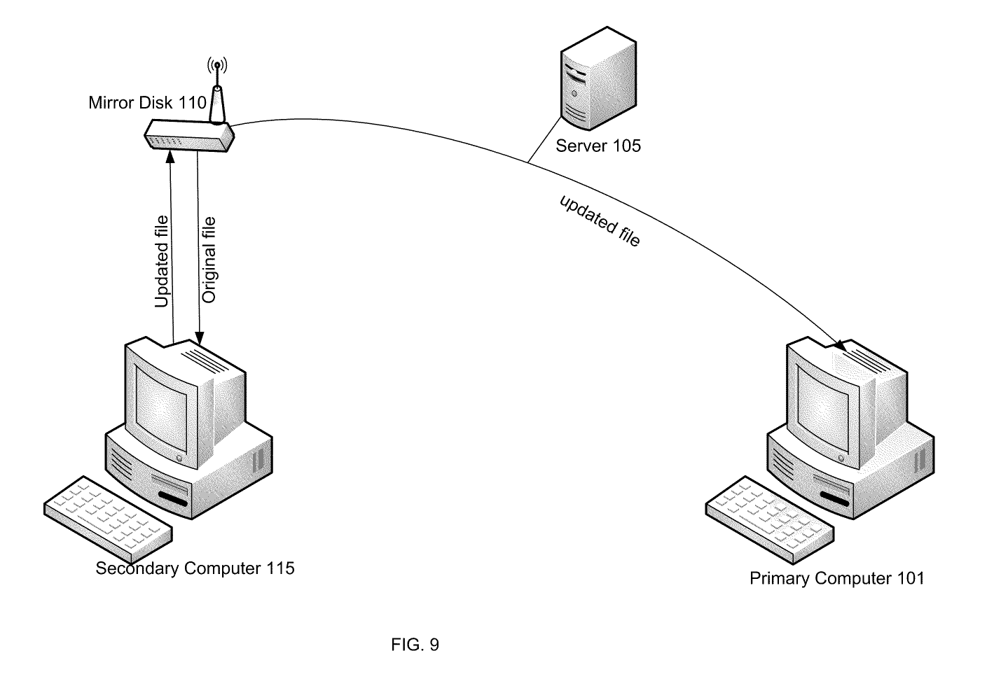

According to another embodiment, illustrated in FIGS. 6-9, the files and directory structure are copied directly between primary computer 101 and mirror disk 110. Remote server 105 is in communication with both mirror disk 110 and primary computer 101. The file copy and directory structure copy operations are initiated and monitored by remote server 105. The operations of FIG. 6 parallel those of FIG. 1; the operations of FIG. 7 parallel those of FIG. 2; the operations of FIG. 8 parallel those of FIG. 3; the operations of FIG. 9 parallel those of FIG. 4.

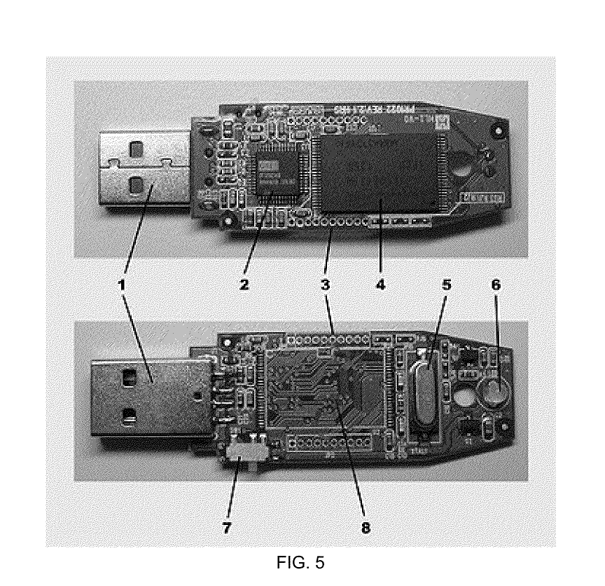

FIG. 5 shows top and bottom views of a mirror disk according to an embodiment of the present invention. Shown in FIG. 5 are USB connector 1 for connecting mirror disk 110 to secondary computer 115; 3G communications chip 2; test points 3; flash memory 4; crystal oscillator 5; LED light (optional) 6; on/off switch 7; space 8 for a sim card holder. According to some embodiments, mirror disk 110 includes a battery. According to other embodiments, mirror disk 110 receives power from an external power source such as secondary computer 115, via USB connection. According to some embodiments wherein a battery is included in mirror disk 110, the battery is charged via USB connection to a power source such as secondary computer 115.

According to certain embodiments, all software for the mirror disk runs on the communications chip. According to other embodiments, an additional chip is added to the mirror disk such as a System-on-a-chip (SoC) commonly employed in mobile phones. One example SoC chip is the MiMagic6 chip developed by Neomagic corporation. This additional chip runs software, inter alia, for initiating requests to remote server 105 for files.

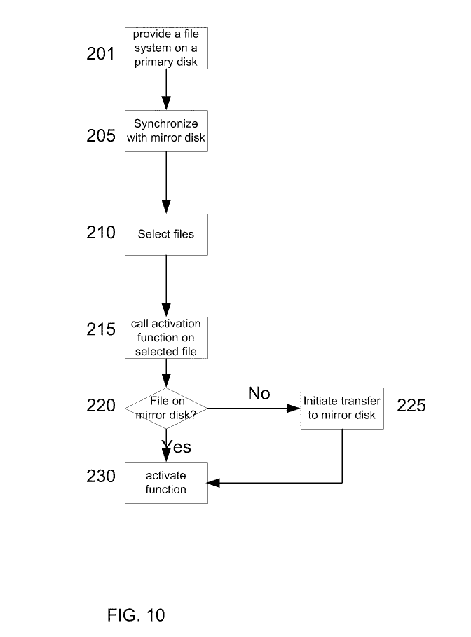

FIG. 10 is a flow chart of a method for opening a file from a primary computer on a remote, secondary computer using a mirror disk. At step 201a file system is provided on a primary disk. At step 205 the directory structure and all filenames are copied to a mirror disk via a remote server in communication with the primary disk over the Internet or intranet a wide area network (WAN), and also with the mirror disk over advanced telephony connection (e.g., 3G) or WAN or Internet. At step 210, a user connects the mirror disk to a secondary computer and browses the primary disk file system on the second computer's display. At step 215, the user calls an activation function, inter alia, copy file or open file, on the selected file of step 210. The mirror disk software determines whether the actual file is stored on the mirror disk at step 220. If the file is stored on the mirror disk, the mirror disk initiates a request to the remote server requesting the file in step 225. The file is then copied either from the remote server to the mirror disk, or from the primary disk to the mirror disk, depending on how the distributed backup system is configured. Once the file has been copied, the function is executed, in step 230. According to a preferred embodiment, when the activation function requires opening a program on the secondary computer, the secondary computer does not wait until the file is copied to the mirror disk before opening the program; rather, the program is opened while the file is being copied to the mirror disk.

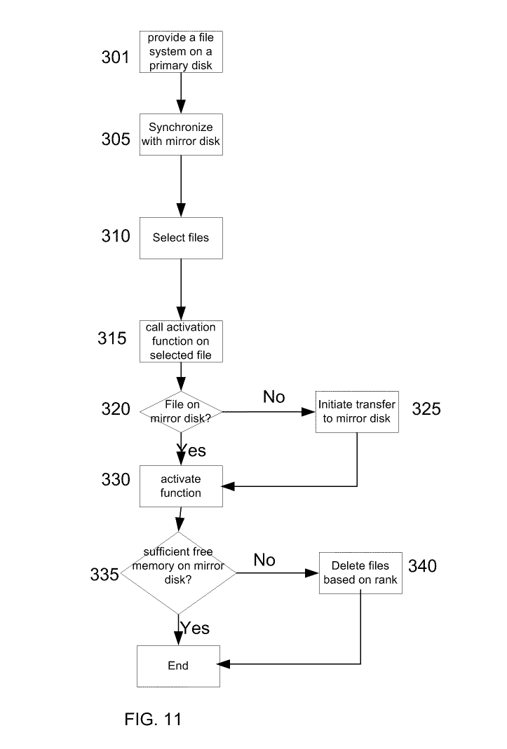

In FIG. 11, steps 301-330 correspond to steps 201-230 of FIG. 10. In addition, FIG. 11 includes the further steps of: checking whether there is sufficient free memory on the mirror disk for subsequent copies of files (step 335). One implementation involves simply determining if a file was copied to the mirror disk at step 325. If there is insufficient memory, freeing memory on the mirror disk (step 340) based on priority rankings similar to algorithms used in computer caches to minimize the number of cache misses. However, in the present invention the units employed in the algorithm are complete files, not double-words of data.

On an abstract level, the system of the present invention can be viewed as a distributed file system that strives to maintain coherence between its distributed portions. In certain embodiments, coherence is maintained by design: the system assumes one user using either the primary computer file system or the mirror disk. In other embodiments, multiple users are envisioned and a potential conflict between versions of a single file or the file system may arise when two users modify the same file without merging the other user's modifications. For many file types, such conflicts are resolved either automatically or one user is presented with a warning notice to either merge or discard his modifications. Such conflict resolution methods are provided, inter alia, by Google Docs for the file types supported by Google Docs. Thus, according to certain embodiments, the present invention allows editing (or, only allows saving edits) to files on the mirror disk of a filetype for which a protocol for conflict resolution is available. This does not limit the functionality to browse files of any type and move, copy and open those files on a secondary computer from the mirror disk. Nor does it restrict adding new files to the mirror disk from a secondary computer.

Alternatively, the mirror disk is only passive for browsing files, opening then on a secondary computer and copying them to a secondary computer But it does not update the primary computer with any modifications done on the mirror disk.

In computing, a distributed file system or network file system is any file system that allows access to files from multiple hosts sharing via a computer network. This makes it possible for multiple users on multiple machines to share files and storage resources.

The client nodes do not have direct access to the underlying block storage but interact over the network using a protocol. This makes it possible to restrict access to the file system depending on access lists or capabilities on both the servers and the clients, depending on how the protocol is designed.

In contrast, in a shared disk file system all nodes have equal access to the block storage where the file system is located. On these systems the access control must reside on the client.

Distributed file systems may include facilities for transparent replication and fault tolerance. That is, when a limited number of nodes in a file system go offline, the system continues to work without any data loss.

The difference between a distributed file system and a distributed data store can be vague, but DFSes are generally geared towards use on local area networks.

Transparency is usually built into distributed file systems, so that files accessed over the network can be treated the same as files on local disk by programs and users. The multiplicity and dispersion of servers and storage devices are thus made invisible. It is up to the network file system to locate the files and to arrange for the transport of the data.

Concurrency control becomes an issue when more than one person or client are accessing the same files and want to update it. Hence updates to the file from one client should not interfere with access and updates from other clients. Concurrency control or locking may be either built into the file system or be provided by an add-on protocol.

One example of a distributed file system is the Andrew File System (AFS). The Andrew File System (AFS) is a distributed networked file system which uses a set of trusted servers to present a homogeneous, location-transparent file name space to all the client workstations. It was developed by Carnegie Mellon University as part of the Andrew Project. It is named after Andrew Carnegie and Andrew Mellon. Its primary use is in distributed computing.

AFS has several benefits over traditional networked file systems, particularly in the areas of security and scalability. It is not uncommon for enterprise AFS cells to exceed twenty five thousand clients. AFS uses Kerberos for authentication, and implements access control lists on directories for users and groups. Each client caches files on the local filesystem for increased speed on subsequent requests for the same file. This also allows limited filesystem access in the event of a server crash or a network outage.

Read and write operations on an open file are directed only to the locally cached copy. When a modified file is closed, the changed portions are copied back to the file server. Cache consistency is maintained by a mechanism called callback. When a file is cached, the server makes a note of this and promises to inform the client if the file is updated by someone else. Callbacks are discarded and must be re-established after any client, server, or network failure, including a time-out. Re-establishing a callback involves a status check and does not require re-reading the file itself. The present invention maintains substantially constant feedback between the remote server and the mirror disk using 3G data communication or constant Internet access. This is an important future of the present invention to maintain coherence.

A consequence of the file locking strategy in AFS is that AFS does not support large shared databases or record updating within files shared between client systems. This was a deliberate design decision based on the perceived needs of the university computing environment. It leads, for example, to the use of a single file per message in the original email system for the Andrew Project, the Andrew Message System, rather than a single file per mailbox.

A significant feature of AFS is the volume, a tree of files, sub-directories and AFS mountpoints (links to other AFS volumes). Volumes are created by administrators and linked at a specific named path in an AFS cell. Once created, users of the filesystem may create directories and files as usual without concern for the physical location of the volume. A volume may have a quota assigned to it in order to limit the amount of space consumed. As needed, AFS administrators can move that volume to another server and disk location without the need to notify users; indeed the operation can occur while files in that volume are being used.

AFS volumes can be replicated to read-only cloned copies. When accessing files in a read-only volume, a client system will retrieve data from a particular read-only copy. If at some point that copy becomes unavailable, clients will look for any of the remaining copies. Again, users of that data are unaware of the location of the read-only copy; administrators can create and relocate such copies as needed. The AFS command suite guarantees that all read-only volumes contain exact copies of the original read-write volume at the time the read-only copy was created.

The file name space on an Andrew workstation is partitioned into a shared and local name space. The shared name space (usually mounted as /afs on the Unix filesystem) is identical on all workstations. The local name space is unique to each workstation. It only contains temporary files needed for workstation initialization and symbolic links to files in the shared name space.

The Andrew File System heavily influenced Version 4 of Sun Microsystems' popular Network File System (NFS). Additionally, a variant of AFS, the Distributed File System (DFS) was adopted by the Open Software Foundation in 1989 as part of their Distributed Computing Environment.

The following Access Control List permissions can be granted:

Lookup (I) allows a user to list the contents of the AFS directory, examine the ACL associated with the directory and access subdirectories.

Insert (i) allows a user to add new files or subdirectories to the directory.

Delete (d) allows a user to remove files and subdirectories from the directory.

Administer (a) allows a user to change the ACL for the directory. Users always have this right on their home directory, even if they accidentally remove themselves from the ACL.

Permissions that affect files and subdirectories include:

Read (r) allows a user to look at the contents of files in a directory and list files in subdirectories. Files that are to be granted read access to any user, including the owner, need to have the standard UNIX “owner read” permission set.

Write (w) allows a user to modify files in a directory. Files that are to be granted write access to any user, including the owner, need to have the standard UNIX “owner write” permission set.

Lock (k) allows the processor to run programs that need to “flock” files in the directory.

Additionally, AFS includes Application ACLs (A)-(H) which have no effect on access to files.

Similar permissions can be granted for access to different filetypes on the mirror disk, based on whether coherence is a concern for each file type, and for those filetypes that coherence is an issue, whether conflict resolution can be implemented by the system.

One example of a system that ensures that data on a plurality of devices are kept in sync is MobileMe offered by Apple Corporation of Cupertino, Calif. MobileMe maintains a synchronized address book and calendar feature using Push functions. If a user makes a change to a contact or event on one device it will be automatically synced to the MobileMe servers and, by extension, all the user's other devices. Supported devices include the iPhone, Address Book and iCal on Mac OS X, or Microsoft Outlook 2003 or later on Microsoft Windows.

MobileMe has a public photo and video gallery feature. Photos and videos can be uploaded in the web browser at me.com, synced by iPhoto or Aperture on Mac OS X or uploaded from the iPhone and iPod Touch. Users can also upload from within applications available on the Mac, including iPhoto and iMovie. MobileMe also provides the user with an e-mail address that is used only for uploading photos and videos. All uploads by viewers of the gallery (either by the iPhone or iPod Touch, me.com, or sent by the dedicated e-mail address), will be synced back to iPhoto, Aperture, and iMovie.

MobileMe features iDisk, a storage repository accessible via a web browser at me.com, Finder on Mac OS X, various Apps for the iPhone OS, or as a remote disk in Microsoft Windows. It also allows sharing of files by placing them in the iDisk Public Folder, while owners can set passwords to protect them. Uses who wish to sync their MobileMe data with a PC must download and install MobileMe Control Panel. To install, the user must first download and install the latest version of iTunes, and then install MobileMe Control Panel. Then the user signs in using their username and password, and then can control sync settings and other various settings.

Any Address Book entries, iCal events and to-do entries, Safari bookmarks and keychains, mail accounts, mail rules, mail signatures, and smart mailboxes can be synched with the iDisk, allowing easy synchronization between multiple computers. iWeb allows users to create web pages that can be uploaded to iDisk and published. iPhoto can be used for one-click web-publishing of photo albums. iCal can be used to publish calendars to the web. Also, Backup software can be used to make backups to iDisk or local media. With the previous .Mac service, the iMovie, iPhoto, GarageBand, and iTunes libraries could easily be uploaded to any iDisk (subject to various licensing agreements).

MobileMe integrates with various applications on the iPhone and iPod touch. This includes iCal syncing with Calendar, Address Book syncing with Contacts, Mail syncing across devices, Safari Bookmarks syncing across devices. Apple later introduced the iDisk application for the iPhone and iPod Touch, which makes it easier for members to access the contents of their iDisk from their iPhone or iPod touch. There is also another iPhone application, MyGallery, which members can use to access their MobileMe photo gallery.

One of the drawbacks of iDisk and MobileMe is that it does not simply synchronize all of a user's files. Rather, it synchronizes only files placed in a specific folder. Also, iDisk and MobileMe do not support synching files to a device when the memory required to store all of the user's selected files exceeds the storage capacity of the device. For example, if an iPod Touch has 2 MB of free space and the user has configured his iDisk (using his iMac computer) to sync 5 MB of files, MobileMe will not provide access to all 5 MB of files on the iPod touch. The present invention overcomes these drawbacks.

Additional descriptions of distributed storage networks and disk duplication are contained in “The Basics of Reliable Distributed Storage Networks,” by Thomas J. Jepsen, published in IT Pro magazine, May-June 2004, and in the book “Distributed Storage Networks: Architecture, Protocols and Management,” by Thomas C. Jepsen, published in 2003 by Wiley, ISBN-10: 04708580205, ISBN-13: 978-0470850206, both of which are included herein by reference.

In accordance with an embodiment of the present invention, a system includes a first disk or hard drive of a first computer; and a flash drive. The first disk or hard drive of a first computer is connected via the Internet or other network to a server. The server monitors data operations on the first disk and creates a remote copy of all files on the first disk. The remote copy is stored remote from the first disk. The flash drive is connected via the Internet or other network to the server. The server stores a copy of all files on the first disk to the flash drive. The server regularly checks for data activity on the first disk and updates (syncs) both the remote copy and the flash drive copy accordingly. According to preferred embodiments, the server regularly checks for data activity on the flash disk and updates (syncs) both the remote copy and the first disk accordingly. In this manner, the data are kept in sync regardless of where the user updated his files: on his personal computer or on the flash drive.

In order to provide connection to the server, the flash drive is coupled to a communication chip. A description of a solid state non-volatile storage system coupled with components that provide the functionality of a cellular telephone, is described in U.S. Pat. No. 7,693,548 for “Mufti-access solid state memory devices and a telephone utilizing such,” by Moran, et al. This patent specification is included herein by reference. According to other embodiments, wifi connectivity is provided to the flash drive by coupling the flash drive with components that provide wifi connectivity.

In accordance with an embodiment of the present invention, the flash drive and first disk are kept in sync using cellular telephone functionality provided to the flash drive. In accordance with an embodiment of the present invention, the flash drive and first disk are kept in sync using wifi functionality provided to the flash drive.

When a user is away from the first disk and wishes to access a file stored on the first disk, the user inserts the flash drive into a second computer that is remote from the first disk. The user browses the file system provided on the flash drive, which is substantially the same as the file system on the first disk, to locate the desired file or files. The user then copies the desired files to the second computer. Alternatively, the user opens the desired files directly off the flash drive using an associated program on the second computer. For example, if the desired file is a PowerPoint presentation, the user runs the Microsoft PowerPoint program on the second computer and opens the desired file off the flash drive.

When a user is away from the first disk and wishes to store a file stored on a second computer to the first disk, the user inserts the flash drive into the second computer. The user browses the second computer's file system to locate and copy the desired file or files. The user then browses the file system provided on the flash drive, which is substantially the same as the file system on the first disk, in order to locate a suitable folder for storing the new files. The user pastes the copied files to the desired location. When the first disk is synced with the flash drive, these new files are copied to the first disk. Also, if the user creates a new folder on the flash drive, this new folder is created on the first disk when the flash drive and first disk are synced. In this way, the user need not perform any operation when he is back at his first disk; the files are copied and stored to a suitable folder automatically when the flash disk and first disk are synced.

Case: Volume of all Files is Larger than Flash Drive

In accordance with an embodiment of the present invention, when the volume of all files on the first disk is larger than the volume of the flash drive the following system is used. The objective is to provide a seamless user experience whereby the user is not made aware which files are physically stored on the flash drive and which are not. Rather, when viewing the file system on the flash drive, the user is presented with substantially the entire file system of the first disk. The user navigates through the file system to select one or more files. When the user performs an action to open or copy the selected one or more files, if the file is stored on the flash drive, the file is opened or copied. If the file is not stored on the flash drive, some files are erased from the flash drive in order to free up sufficient memory for the selected files, and the selected files are copied to the flash drive from the remote server or from the first disk, depending on the architecture of the backup system. When the files have been stored to the flash drive the user activity is performed (e.g., open the files or copy the files).

In order to provide a seamless user experience, the data comprising the entire file system are prioritized. A volume of data roughly equal to the amount of free storage space on the flash drive and having the highest priorities from among all the data in the file system are stored on the flash drive; the remaining data are not stored on the flash drive. In some instances it is advantageous to maintain a certain amount of free memory, e.g., 200 MB or more, for use by the system. In this case, a volume of data roughly equal to the amount of free storage space on the flash drive minus the amount of free memory are stored on the flash drive. Also, it is at times advantageous to avoid deleting files in order to make room for remote files. For instance, the delete operation may take time. Thus, a portion of free space is allocated for storing files that are not present on the flash drive. In this case, when the selected files are not already stored on the flash drive, they are copied to the free space without first deleting files to make space. After the files have been copied and the user activity (e.g., open or copy) has been performed, files having the lowest priority from among those on the flash drive are deleted in order to re-allocate the desired volume of free space on the flash drive. The amount of free space is adjusted based on the amount of space used each time to download files not already stored on the flash drive by the user. For example: the average amount of space used by the user during the last 20 uses; or, the maximum amount of space used by the user during the last 20 uses; or, the greater of a fixed amount (e.g., 200 MB) and the maximum ever used by the user; or, the greater of a fixed amount (e.g., 200 MB) and the maximum used by the user within a window of time such as 1 year. It will be appreciated that many variations on these measures can be used, as well as other measures.

### How to Prioritize Data

In accordance with an embodiment of the present invention, data in the first disk's file system are prioritized for storing on the flash drive. The highest priority is assigned to the directory structure, filenames, and metadata used for navigating the file system. By storing all data required for navigating the entire first disk's file system on the flash drive at all times, the user is ensured the fastest response time while navigating the file system. This is essential for a smooth user experience. In order to store only the directory structure, filenames, and metadata, but not the entire file data, on the flash drive, the metadata are stored external to the actual file data. A brief description of file systems is presently provided.

Most file systems make use of an underlying data storage device that offers access to an array of fixed-size physical sectors, generally a power of 2 in size (512 bytes or 1, 2, or 4 KiB are most common). The file system is responsible for organizing these sectors into files and directories, and keeping track of which sectors belong to which file and which are not being used. Most file systems address data in fixed-sized units called “clusters” or “blocks” which contain a certain number of disk sectors (usually 1-64). This is the smallest amount of disk space that can be allocated to hold a file.

However, file systems need not make use of a storage device at all. A file system can be used to organize and represent access to any data, whether it's stored or dynamically generated (e.g., procfs).

A file name is a name assigned to a file in order to secure storage location in the computer memory. By this file name a file can be further accessed. Whether the file system has an underlying storage device or not, file systems typically have directories which associate file names with files, usually by connecting the file name to an index in a file allocation table of some sort, such as the FAT in a DOS file system, or an inode in a Unix-like file system. Directory structures may be flat, or allow hierarchies where directories may contain subdirectories. In some file systems, file names are structured, with special syntax for filename extensions and version numbers. In others, file names are simple strings, and per-file metadata is stored elsewhere. The term “metadata” covers a variety of data and in the context of the present invention, this term includes any subset of what is included in the document “Understanding Metadata,” ISBN: 1-880124-62-9, published by NISO, a non-profit association accredited by the American National Standards Institute (ANSI).

Resuming now to the subject of prioritizing data, after the directory structure, filenames, and metadata, subsequent priority levels are assigned to the data files based on usage statistics. These statistics include, inter alia, how recently the file was accessed by the user on either the first disk or on the flash disk; the number of times the file was accessed by the user within a window of time, such as one year or 3 months. In addition, the user may define certain folders as “high priority” and all files contained in these folders are assigned high priority without regard for usage statistics. When a first file that was not present on the flash disk is transferred to the flash disk to be used, that first file's priority ranking is increased due to its present use. Accordingly, a second file whose priority ranking is now lower than the first file's priority ranking may be deleted from the flash drive whereas the first file is retained on the flash drive. This transfer can be inter alia, transfer of data that is stored on the first disk; it can also be a file not present on the first disk but transferred from a second computer onto the flash drive.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A handheld, dynamically updated mirror disk, comprising:
a solid state memory;
components operative to perform read and write operations on said memory;
communication means operative to transfer data from a remote server to said memory and from said memory to said server;
connection means operative to (i) connect the mirror disk to a first computer, and (ii) transfer data between said first computer and said mirror disk;
wherein a file system comprising a plurality of document files arranged in at last one directory are stored on a second computer, and wherein said remote server copies the entire directory structure and all filenames of said file system to said solid state memory over said communication means;
wherein after said file system is updated on said second computer, said remote server synchronizes, over said communication means, said file system directory structure and filenames on said solid state memory to match said updated file system;
wherein when the mirror disk is connected to said first computer, said first computer displays said file system;
wherein when a user of said first computer (i) selects at least one of said document files in said file system display, and (ii) issues an instruction to perform an action on said at least one document file, said action is executed by said first computer using a version of said at least one document file stored on said solid state memory.

2. The mirror disk of claim 1, further comprising a housing substantially the dimensions of a disk-on-key, said housing enclosing said memory, said components and said communication means.

3. The mirror disk of claim 1, wherein said connection means connects physically to said computer.

4. The mirror disk of claim 3, wherein said connection means conforms to a universal serial bus (USB) standard.

5. The mirror disk of claim 1, wherein said connection means connects wirelessly to said computer.

6. The mirror disk of claim 5, wherein said connection means conforms to a Bluetooth standard.

7. The mirror disk of claim 1, wherein said remote server copies all of said file system to said solid state memory over said communication means;

8. The mirror disk of claim 7, wherein after at least one document file is modified on said second computer, said remote server synchronizes, over said communication means, said at least one document file on said solid state memory to match said modified at least one document file.

9. The mirror disk of claim 7, wherein after at least one document file is added on said second computer, said remote server copies, over said communication means, said at least one added document file to said solid state memory.

10. The mirror disk of claim 1, wherein after at least one document file is copied from said first computer to a location in said file system on said mirror disk, said remote server copies, over said communication means, said at least one added document file to a respective location in said file system on said second computer.

11. The mirror disk of claim 1, wherein after at least one document file on said mirror disk is modified by said first computer, said remote server synchronizes, over said communication means, said at least one document file on said second computer to match said modified at least one document file.

12. The mirror disk of claim 1, wherein if at the time said user of said first computer issues said instruction, a version of said at least one document file is not stored on said solid state memory, said remote server copies, over said communication means, said at least one document file to said solid state memory.

13. The mirror disk of claim 1, wherein if at the time said user of said first computer issues said instruction, a version of said at least one document file is not stored on said solid state memory, said remote server deletes at least one file from said solid state memory and copies, over said communication means, said at least one document file to said solid state memory, said deletion freeing sufficient memory to store said at least one copied file.

14. The mirror disk of claim 10, wherein when a user copies at least one document file from said first computer to a location in said file system on said mirror disk, said mirror disk deletes at least one file from said solid state memory, said deletion freeing sufficient memory to store said at least one copied file.

15. A method providing copies of files in multiple locations, the method comprising:
providing a file system on a primary computer;
synchronizing said file system on a mirror disk by means of a remote server;
enabling file system operations on said synchronized file system using a secondary computer connected to said mirror disk.

16. The method of claim 15, wherein said file system operations include copying a file from said secondary computer to a location within said synchronized file system on said mirror disk, the method further comprising copying said copied file to said location within said primary computer file system by means of said remote server.

17. The method of claim 15, wherein said file system operations include modifying a file from said synchronized file system, the method further comprising synchronizing said modified file with said primary computer file system by means of said remote server.

18. The method of claim 15, wherein said file system operations include the steps of:
calling a function on a selected file;
determining whether said selected file is stored on said mirror disk;
if said selected file is not stored on said mirror disk, copying said selected file to said mirror disk by means of said remote server; and,
executing said function on said copied file.

19. The method of claim 18, further comprising:
generating priority rankings for a plurality of files a said mirror disk;
after copying said selected file to said mirror disk, deleting at least one file from said mirror disk based said priority rankings.
